(19) United States
(12) Patent Application Publication
(10) Pub. No.: US 2017/0275123 A1
(43) Pub. Date: Sep. 28, 2017

(54) Stacking Device, Stack Holder, And Sorting System For Sorting Flat Objects

(71) Applicant: SIEMENS AKTIENGESELLSCHAFT, MUENCHEN (DE)

(72) Inventor: PETER Berdelle-Hilge, KONSTANZ (DE)

(73) Assignee: SIEMENS AKTIENGESELLSCHAFT, Muenchen (DE)

(21) Appl. No.: 15/504,961

(22) PCT Filed: Jul. 28, 2015
(86) PCT No.: PCT/EP2015/067285

§ 371 Date: Feb. 17, 2017

(30) Foreign Application Priority Data
Aug. 22, 2014 (DE) 10 2014 216 791.4

(51) Int. Cl. B65H 31/06; B07C 3/00

(52) U.S. Cl. CPC B65H 31/06; B07C 3/008; B65H 2301/42146; B65H 2301/422548; B65H 2301/4263; B65H 2301/42632

(57) ABSTRACT

A stacking device for flat objects standing upright stacks the objects to form a stack which increases in a stacking direction. The stacking device includes at least one stacking point at which the objects are respectively added to the stack. The stacking device also includes at least one stack holder drive with which at least one stack holder receiving the stack can be moved in the stacking direction relative to the stacking point. A stack holder for a stack of flat objects standing upright and a sorting system for sorting flat objects including a plurality of stacking devices, are also provided.

The invention relates to a stacking device for flat objects standing upright, in which the objects are stacked to form a stack which increases in the direction of stacking, comprising at least one stacking point at which the objects are respectively added to the stack.

Stacking devices of the aforementioned type are known for example from DE 199 61 513 C1 and also from U.S. Pat. No. 6,634,639 B2 and are used in mail sorting systems for example. The flat objects of different size, shape, mass and surface, for example letters or postcards, are fed out into the stack devices of a sorting system and formed into a stack. The objects are arranged in the stack standing upright and usually aligned on two edges. When a new object is fed in the object previously fed in acts as a guide surface. When the stack has reached a predetermined maximum length the stack must be removed from the stacking device by an operator. The removed stack is usually used to fill a container, which is used for intermediate storage and/or for further transport of the stack. With a high throughput of objects the stacking devices have to be emptied very frequently, which involves a great deal of effort for the operator. If a stacking device is not emptied in good time no further objects can be fed into the stacking device, which is problematic.

To solve this problem a sorting machine, which has stacking devices that stack the objects in each case in an exchangeable container, a so-called cartridge, is described in U.S. Pat. No. 5,857,830 for example. These exchangeable containers, when they are full up, can be removed automatically and replaced by an empty exchangeable container. This means that the stacking device is quickly available again. However the system described is complex in its construction and thereby relatively cost intensive.

The object of the present invention is therefore to provide a stacking device of the type stated at the outset, which is able to be emptied quickly and easily and which has a simple mechanical design.

In accordance with the invention the object is achieved by the stacking device of the type stated at the outset, by the stacking device having at least one stack holder drive by means of which at least one stack holder accommodating the stack can be moved in the direction of stacking with respect to the stacking point.

The invention further relates to a stack holder for a stack comprising flat objects standing upright, with a floor that embodies a supporting plane for an edge of the objects and on which the objects are able to be arranged to form a stack which increases in the direction of stacking, and with a front wall delimiting the supporting plane in the direction of stacking and arranged in relation to the floor in a fixed position at least during stacking, which is embodied to hold at least one part of the stack in the direction of stacking, wherein the stack holder is embodied for movement relative to a stacking device which moves the objects into the stack holder.

The advantage of the inventive solution is that the stack holder, which does not belong to the stacking device, by its relative movement in relation to the stacking device, does not need any movable stack support and can thereby be of an especially simple mechanical design. Instead, with the inventive stack holder, the front wall, which is moved with the floor relative to the stacking device, serves as a front support for the stack, which creates a necessary stack pressure and forms a supporting surface for the first object to be added to the stack.

The stack holder separate from the stacking device can be removed easily from the stacking device and be replaced by an empty stack holder, so that a stacking device overflow can be avoided. The stack holder can be exchanged both manually and also automatically.

The invention can be developed by further advantageous embodiments, which are described below.

Thus the stacking device can comprise at least one separation device, through which, at least for a time, a distance between the stacking point and the stack is able to be created in the direction of stacking. The advantage of this is that a rear wall of the stack holder or a stack support of the stack holder can be inserted into the space created without there being any influence on the stack. This is of particular advantage for automated replacement of the stack holder. Furthermore the separation device can include a holder means embodied for movement in the direction of stacking, in order to move the rear end of the stack in the direction of stacking and in order to create the distance.

In a further advantageous embodiment the stacking device can have at least one transverse drive by which the at least one support element is able to be moved, for example transverse to the direction of stacking. This has the advantage that the support element belonging to the stack holder is taken out of the stack holder automatically and can be inserted into the stack and into the stack holder. The support element can be a rear wall and/or a stack support of the stack holder.

In an advantageous development of the stack holder, said holder can have at least one stop rib running essentially in the supporting plane and in the direction of stacking, which forms a stop surface for the objects when they are being added to the stack. The advantage of this is that the stack is aligned in the stack holder on the stop surface, whereby the stack is better able to be further processed. In order to prevent the objects slipping, the floor of the stack holder can be provided with a type of saw tooth profile transverse to the direction of stacking.

To enable a number of stack holders removed from the stacking device to be stacked one above the other, the stack holder can be able to be transferred from a filling position into a storage position, wherein, in the storage position, the stack holder is able to be stacked with further stack holders one above the other and in the filling position objects are able to be arranged on the supporting plane. The stack holder can have at least one support element delimiting the supporting plane against the direction of stacking and the support element can be embodied for repeated removal, pivoting relative to the floor and displacement relative to the floor. The supporting element can be embodied as the rear wall or as a stack support. Furthermore the stack holder can have a tray able to be displaced relative to the floor. The tray can be embodied for example in a U shape. The support points or the tray respectively form support surfaces above the stack on which a further stack holder can be placed.

In order to support a stack to prevent it falling over in the stack holder, the stack holder can include at least one stack support for holding at least a part of the stack in the direction or against the direction of stacking, wherein the stack support is embodied so that it is able to be arranged in a fixed position relative to the floor in the direction of stacking.

The invention further relates to a sorting system for sorting flat objects with a number of stacking devices, in which the sorted objects are able to be output in each case and are able to be stacked into a stack increasing in a direction of stacking. In order to be able to empty the stacking devices of the sorting system easily and to be able to embody the sorting system as a simple mechanical design, at least one stacking device is embodied in accordance with one of the claims specified above. Furthermore the inventive sorting system can have at least one stack holder of the type stated above.

The invention is explained below with reference to the forms of embodiment given by way of example in the enclosed drawings, in which:

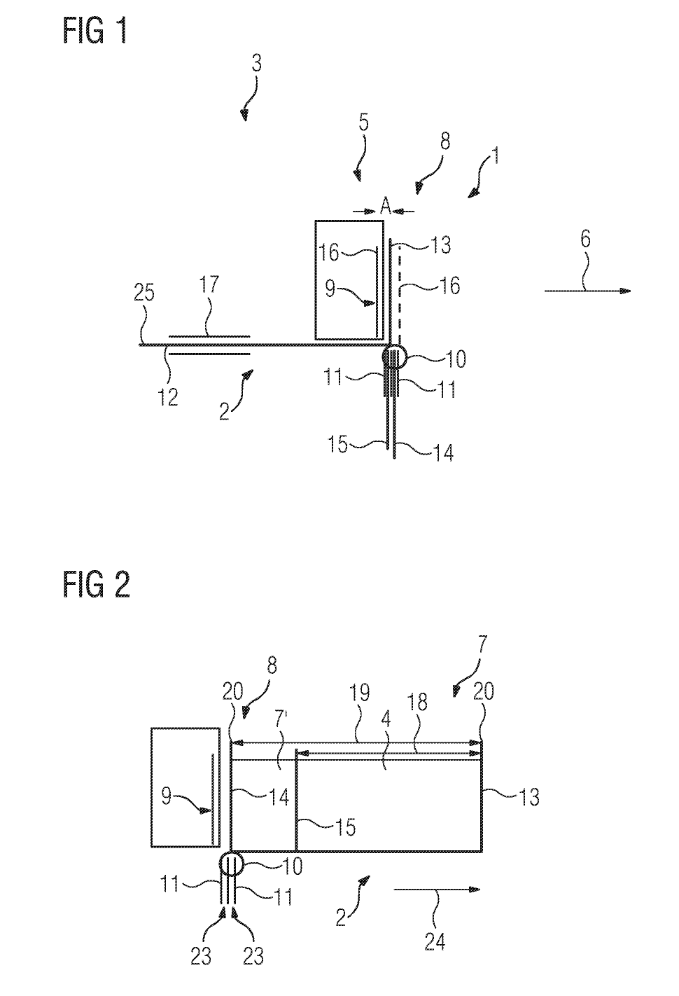

FIGS. 1 and 2 show a schematic diagram of a first form of embodiment of the inventive stacking device and stack holder;

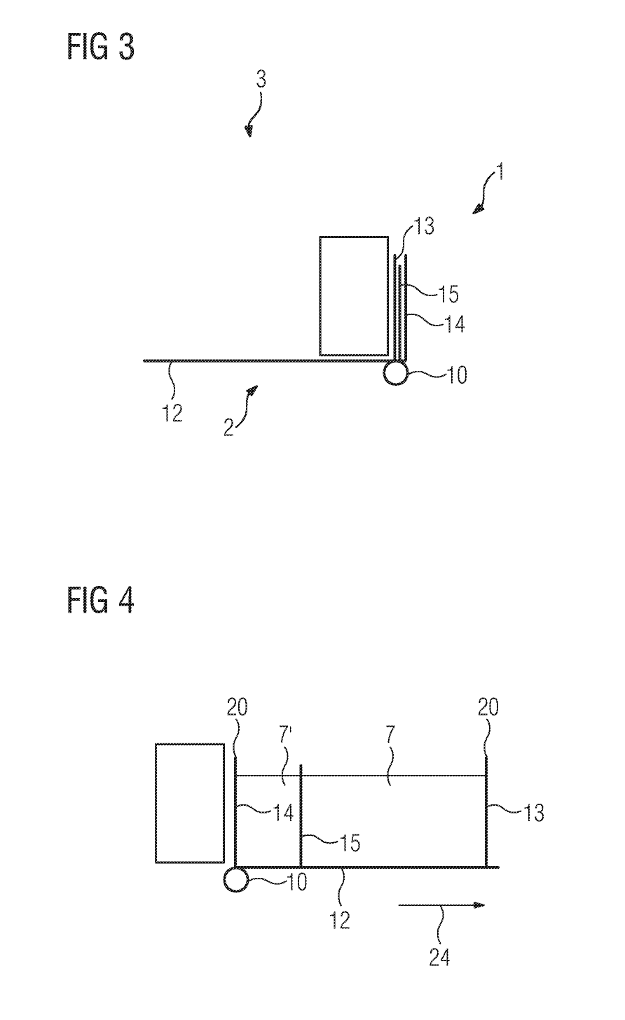

FIGS. 3 and 4 show a further form of embodiment of the inventive stacking device and stack holder;

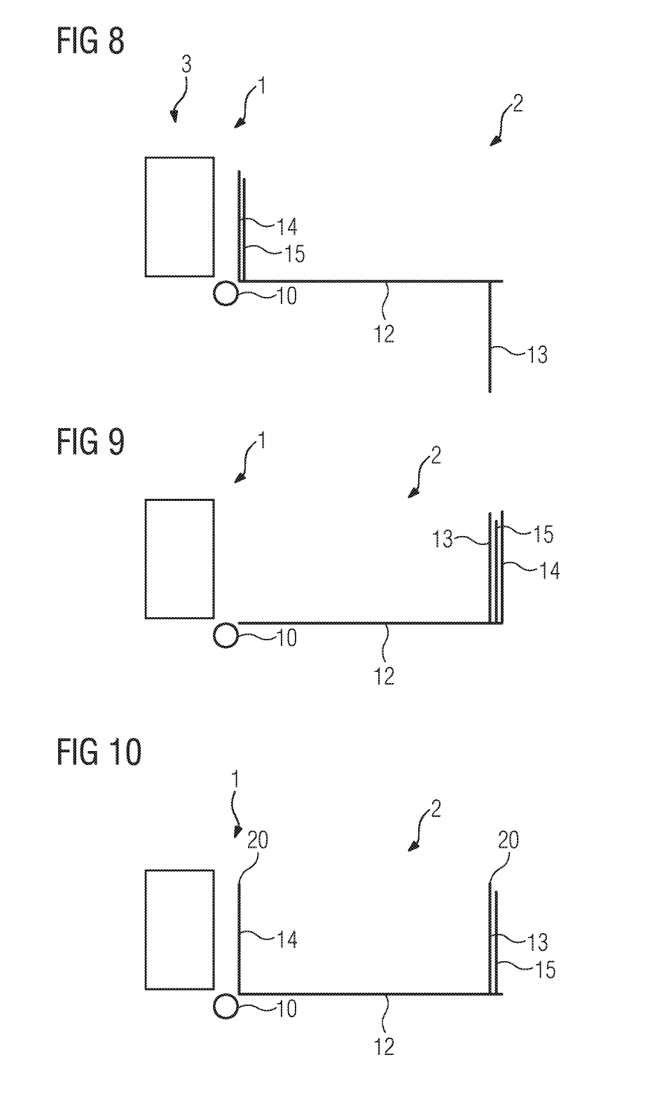

FIGS. 5 to 10 show schematic diagrams of a further form of embodiment of the inventive stacking device and stack holder;

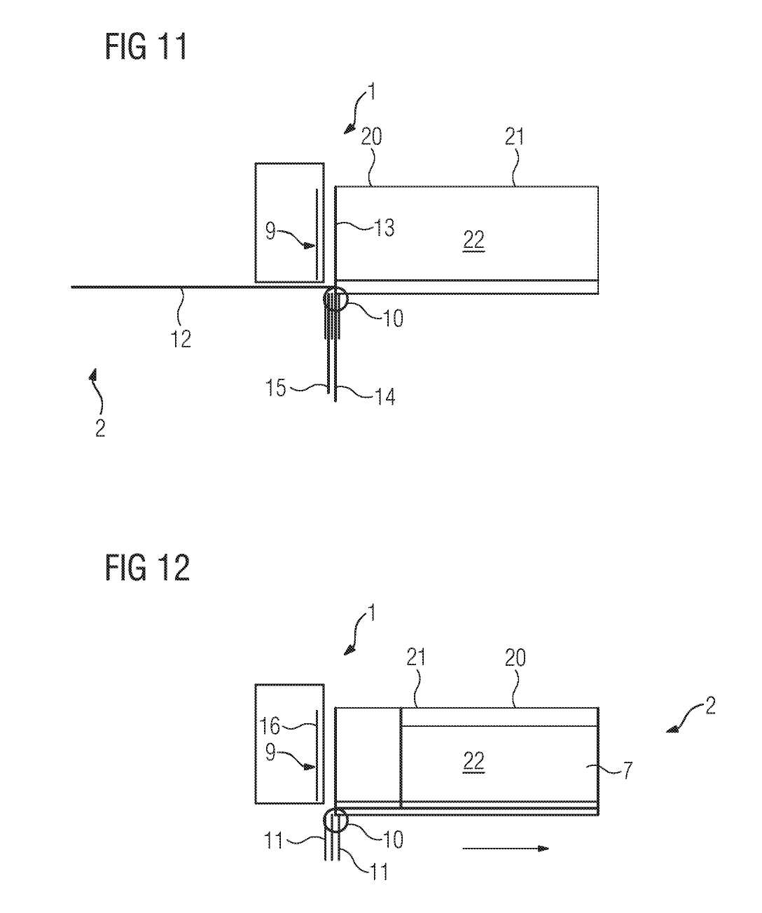

FIGS. 11 and 12 show a schematic diagram of a further form of embodiment of the inventive stacking device and stack holder;

First of all the invention will be described with reference to the exemplary form of embodiment of FIGS. 1 and 2.

FIGS. 1 and 2 show an exemplary form of embodiment of the inventive stacking device 1 and of an inventive stack holder 2, which are arranged in an inventive sorting system 3. FIGS. 1 and 2 each show a section of the sorting system 3, which is embodied for sorting flat objects 4, such as letters or postcards for example, and which has a number of sorting outputs 5. Each sorting output 5 is provided with a stacking device 1, in which the objects 4 can be stacked to form a stack 7 increasing in the direction of stacking 6.

The stacking device 1 includes a stacking point 8, a separation device 9, a stack holder drive 10 and two transverse drives 11.

The stack holder 2 has a floor 12, a front wall 13, a rear wall 14 and a stack support 15.

The floor 2 forms a supporting plane 25. Front wall 13, rear wall 14 and the stack support 15 stand essentially at right angles to the floor 12.

The stacking point 8 of the stacking device 1 is embodied for adding the objects 4 to the stack 7. The stacking point 8 is located at the end of a transport device (not shown) of the sorting system 3, which transports the objects 4 individually standing upright to the stacking point 8. At the stacking point 8 the objects 4 are added into the stack 7 in the direction of stacking and in this case they are aligned transverse to the plane of the drawing. A new object 4 to be added to the stack is conveyed from the sorting system 3 to the corresponding sorting output 5 and is added to the stack 7 at the stacking point 8.

The stack holder drive 10 is a friction wheel drive for example, which in the exemplary form of embodiment of FIGS. 1 and 2, is arranged below the stacking point 8 and is able to be brought into engagement with the stack holder 2.

In the exemplary form of embodiment of FIGS. 1 and 2 the separation device 9 includes a holder means 16 that is arranged transverse to the direction of stacking 6 and is embodied for holding the stack 7. The separation device 9 also has a drive, not shown in the figures, by which the holder means 16 is able to be brought into a feed position shown in FIG. 1 by a dashed line. In this feed position the holder means 16 is at a distance A from the stacking point 8. In the direction of stacking 6 the holder means 16 is arranged in the feed position essentially behind the positions of the rear wall 14 and of the stack support 15 in the respective transverse drives 11.

The function of the inventive stacking device 1 and the inventive stack holder 2 are described below with reference to FIGS. 1 and 2.

In FIG. 1 the stack holder 2 is located in a start position, in which no objects 4 have yet been added into the stack. In this position the stack holder 2 is pushed into a stack holder guide 17 of the stacking device 1 so that the stack holder drive 10 is engaging with the underside of the floor 12. As an alternative to the friction wheel drive shown in the figures, the stack holder drive 10 can of course also be embodied as a toothed-wheel drive or toothed-belt drive, and the stack holder 2 can have corresponding teeth that are able to be brought into engagement with the stack holder drive 10. The stack support 15 and the rear wall 14 are each located in a corresponding receptacle 23 of the assigned transverse drive 11, so that they are arranged separated from the floor 12 and the front wall 13 and can be moved relative to these. The stack support 15 and the rear wall 14 are each guided to the stack holder 2 from below.

Subsequently objects 4 are stacked in from the stacking point 8, as already described above and the stack 7 increases in the direction of stacking 6 standing upright on the floor. In this case the stack holder 2 is moved successively by the stack holder drive 10 in the direction of stacking 6. The speed of advance of the stack holder 2 is thus similar to or equal to a speed of increase of the stack 7. When a predetermined maximum stack length 18 is reached, the stack support 15 will be inserted by the transverse drive 11 into the floor 12 of the stack holder 2. For this to be done, the separation device 9 first creates the distance A between the holder means 16 and the stacking point 8 and thereby approximately the same distance A between the stack 7 and the stacking point 8. A gap is produced between stacking point 8 and stack 7. Now the transverse drive 11 can move the stack support 15 into the gap, transverse to the direction of stacking 6, without there being any influence of the stack 7. This advancing process can be carried out before the next object 4 reaches the stacking point 8. As an alternative the controller of the sorting system 3 can switch the stacking device 1 off for a short time or can buffer objects 4 or divert them to another stacking point, if objects are not to be stacked at this point thereafter. After the stack support 15 has been inserted, a further stack 7′ can be stacked into the stack holder 2. When a maximum total volume of the stack holder 2 is reached, the rear wall 14 is added by the second transverse drive 11 of the stack holder 2. This occurs in the same way as the insertion of the stack support 15 described above. FIG. 1 shows the stack holder 2 in a filling position in which the stacking point 8 can add objects 4 into the stack.

FIG. 2 shows the state after the rear wall 14 has been inserted. In this position the stack holder 2 can be removed from the stacking device 1 and the sorting system 3 and an empty stack holder 2 can be assigned to the stacking device 1. FIG. 2 shows the stack holder 2 already in a storage position, into which it has been brought by the addition of the rear wall 14. The addition of the rear wall 14 gives the stack holder 2 a number of support points 20 on which further stack holders 2 can be placed. This enables a stack of stack holders 2 arranged one above the other to be formed, which makes it easier to store and handle the stack holders 2. The rear wall 14 thus forms a support element of the stack holder 2 together with the front wall and possibly the stack support.

Subsequently the filled stack holder 2 can be removed from the stacking device 1 in a removal direction 24. A new empty stack holder 2 can subsequently be added in the opposite direction to the removal direction 24. As an alternative the drive 10 can also be arranged so that it engages from above into the stack holder. In this way removal downwards and insertion from below would then also be possible.

The form of embodiment of the stacking device 1 and the stack holder 2 shown in FIGS. 1 and 2 is embodied for an automatic manipulation of stack support 15 and rear wall 14.

As an alternative the stack support 15 and the rear wall 14 can also be manipulated manually, which is described below with reference to FIGS. 3 and 4. For the sake of simplicity only the differences from the exemplary form of embodiment of FIGS. 1 and 2 will be discussed.

At the beginning of the stacking-in process in FIG. 3 the stack support 15 and the rear wall 14 are arranged next to the front wall 13. Sensibly, for automatic manipulations in FIGS. 1 and 2, rear wall 14 and stack support 15 are initially arranged in the empty stack holder 2 (empty position) to the left of the front wall 13. With the manual manipulating shown here in FIG. 3 they are arranged to the right of the front wall 13. A manual removal of the stack support 15 and the rear wall 14 upwards from their empty position is thus possible. By contrast, in the form of embodiment of FIGS. 1 and 2, the stack support 15 and the rear wall 14 have each automatically been removed downwards from the empty position and also inserted from below. The stacking device 1 of FIGS. 3 and 4 does not have any transverse drives since the stack support 15 and the rear wall 14 are moved manually.

The invention will be described below with reference to the exemplary form of embodiment of FIGS. 5 to 10.

New descriptions will only be given for the differences from the previous forms of embodiment. The stacking device 1 of FIGS. 5 to 10 is essentially embodied the same as the stacking device 1 of FIGS. 3 and 4. By contrast with the form of embodiment of FIGS. 3 and 4, the stack holder 2 of FIGS. 5 to 10 is embodied with a movable front wall 13.

FIG. 5 shows the stack holder 2 in the filled position.

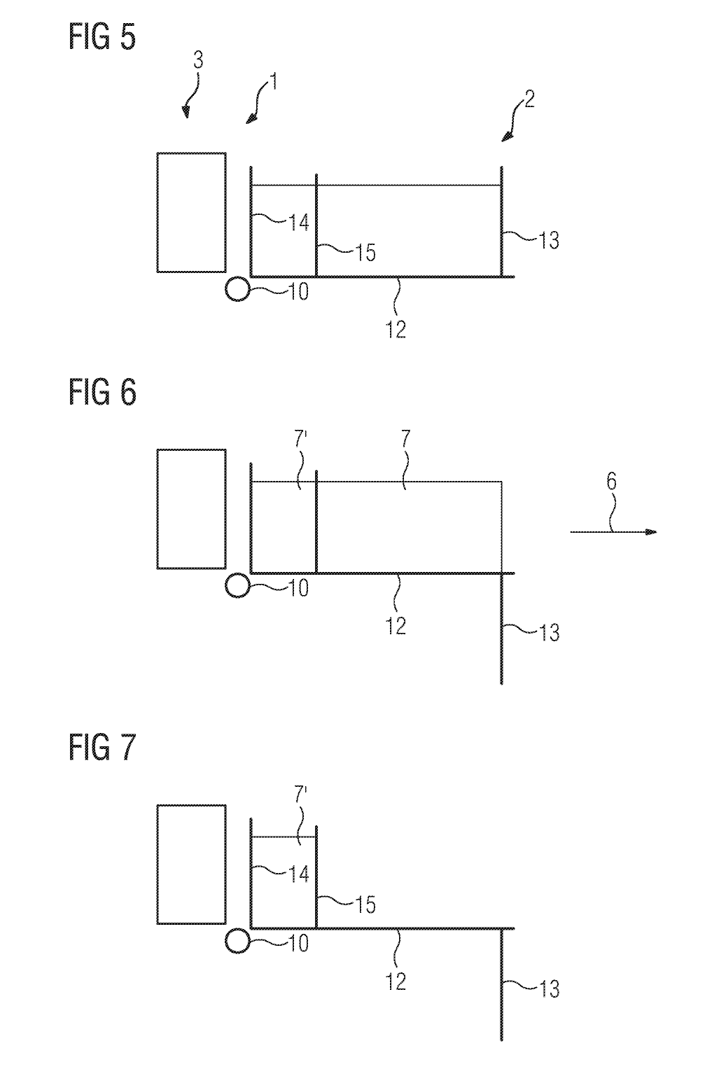

In FIG. 6 the front wall 13 has been moved downwards compared to FIG. 5 so that the stack 7 can be removed in the direction of stacking 6 downwards from the stack holder 2, as shown in FIG. 7. Subsequently the second stack 7′ can also be taken out of the stack holder 2. Subsequently the front wall 13, the rear wall 14 and the stack support 15 will be brought into a position on the far right, as shown in FIG. 9. This can also be sensible for automatic operation.

FIG. 9 shows the stack holder 2 in the operating position in which it is brought into engagement with the stacking device. In the operating position all elements projecting transversely in relation to the floor, which would block an introduction into the stack holder guide 17, are removed.

FIG. 10 shows the stack holder 2 with front wall 13 and rear wall 14 arranged to the side in each case, on which a further stack holder 2 is able to be placed.

The further form of embodiment of the stacking device 1 and the stack holder 2 of FIGS. 11 and 12 will be described below. For the sake of simplicity, new descriptions will only be given for the differences from the previous forms of embodiment. The stacking device 1 of FIGS. 11 and 12 is essentially embodied the same as that of the form of embodiment of FIGS. 1 and 2. The stack holder 2 of FIGS. 11 and 12 is essentially embodied the same as that of the form of embodiment of FIGS. 1 and 2, wherein the stack holder 2 additionally comprises a tray 21. When viewed in the direction of stacking 6, the tray is essentially embodied as a U shape, wherein the side limbs 22 have roughly the height of the front wall 13 and the rear wall 14 or are higher. The width of the tray 21 roughly corresponds to that of the floor 12. During the stacking-in process the floor 12 with the front wall 13 is moved relative to the tray 21. In FIG. 12, at the end of the stacking-in process, the floor 12 is pushed fully into the tray 21. In this way the tray 21 forms support points 20 on which further stack holders 2 are able to be arranged.

1-11. (canceled)

12. A stacking device for stacking flat objects standing upright to form a stack increasing in a stacking direction, the stacking device comprising:
at least one stacking point for respectively adding the flat objects standing upright to the stack;
at least one stack holder for receiving the stack; and
at least one stack holder drive for moving said at least one stack holder in said stacking direction relative to said stacking point.

13. The stacking device according to claim 12, which further comprises at least one separation for creating a distance from time to time between said stacking point and the stack in said stacking direction.

14. The stacking device according to claim 12, wherein said separation device includes a holder device being movable in said stacking direction.

15. The stacking device according to claim 12, which further comprises at least one support element and at least one transverse drive for moving said at least one support element.

16. A stack holder for a stack of flat objects standing upright, the stack holder comprising:
a floor forming a supporting plane for one edge of the flat objects standing upright and being configured to receive the objects on said floor to form a stack increasing in a stacking direction;
a front wall delimiting said supporting plane in said stacking direction, said front wall being disposed, at least during stacking, in a fixed location relative to said floor, and said front wall being constructed for holding at least one part of the stack in said stacking direction; and
the stack holder being configured for relative movement in relation to a stacking device moving the objects into the stack holder.

17. The stack holder according to claim 16, which further comprises at least one stop rib extended substantially in said supporting plane and in said stacking direction, said at least one stop rib having a stop surface for stopping the objects upon being added to the stack.

18. The stack holder according to claim 16, wherein the stack holder is configured to be converted from a filling position into a storage position, the stack holder is configured to be stacked with further stack holders one above the other in said storage position and the stack holder is configured to permit the objects to be disposed on said supporting plane in said filling position.

19. The stack holder according to claim 18, which further comprises at least one support element delimiting said supporting plane in a direction opposite to said stacking direction, said at least one support element being configured to be repeatedly removed, pivoted relative to said floor or displaced relative to said floor.

20. The stack holder according to claim 18, which further comprises a tray configured to be displaced relative to said floor.

21. The stack holder according to claim 16, which further comprises at least one stack support for holding at least one part of the stack in or against said stacking direction, said at least one stack support being configured to be disposed in a fixed position relative to said floor in said stacking direction.

22. A sorting system for sorting flat objects, the sorting system comprising:
a plurality of stacking devices configured to output and to stack sorted objects to form a stack increasing in a stacking direction;
at least one of said stacking devices being constructed according to claim 12.
